(19) United States
(12) Patent Application Publication
(10) Pub. No.: US 2006/0293952 A1
(43) Pub. Date: Dec. 28, 2006

(54) Debit card incentive system and method

(76) Inventors: G. Randy Nicholson, Abilene, TX (US); Steve Covington, New Braunfels, TX (US)

Correspondence Address: STEVEN W. SMITH, 7237 BIRCHWOOD DRIVE, DALLAS, TX, 75240, US

(21) Appl. No.: 11/225,693

(22) Filed: Sep. 13, 2005

Related U.S. Application Data
(63) Continuation-in-part of application No. 11/158,674, filed on Jun. 22, 2005.

(51) Int. Cl. G06Q 30/00

(52) U.S. Cl. 705/14

(57) ABSTRACT

A system and method for encouraging a customer utilizing a financial card to perform a debit-type financial transaction rather than a credit-type transaction at a merchant. The customer is offered a price-per-unit (PPU) discount for fuel as a reward for performing the debit-type financial transaction. A point-of-sale (POS) system at the merchant determines that the customer performed the debit-type transaction, and stores the PPU discount and a customer identifier in a Discounts-Earned database. When the customer initiates a subsequent purchase of fuel, at the merchant or a different retail fueling merchant, a fuel dispenser retrieves the PPU discount from the database, discounts the posted price of the fuel by the PPU discount, and dispenses fuel to the customer at the reduced price. A redeemed discounts calculator multiplies the PPU discount by the number of units purchased in the fueling transaction, and a clearing mechanism allocates the redeemed discount between the merchant and the retail fueling merchant.

### RELATED APPLICATIONS

This application is a continuation-in-part of co-pending U.S. patent application Ser. No. 11/158,674 filed Jun. 22, 2005.

### BACKGROUND OF THE INVENTION

This invention relates to automated retail systems and methods. More particularly, and not by way of limitation, the invention is directed to a system and method for providing a customer with an incentive to select a debit-type financial transaction rather than a credit-type transaction when making a purchase at a point-of-sale (POS) system.

Financial card authorization networks charge retailers a fee for processing credit and debit card transactions. The network fee for processing credit card transactions is higher than the fee for processing debit card transactions. Therefore, from the retailer's perspective, it is desirable to encourage customers to use debit cards rather than credit cards. Additionally, many cards are “dual-mode” cards, which can be used as either a debit or a credit card. Retailers also find it desirable to encourage customers to use their dual-mode cards as debit cards rather than credit cards.

To achieve this objective, the POS system must be able to identify a card as being a credit-only card, a debit-only card, or a dual-mode card when it is swiped at the payment terminal. Currently, many POS systems make this identification by requesting the customer to select either Credit or Debit when beginning the transaction. This approach, however, may result in the customer selecting a mode of payment that is not valid for the particular card. If the customer makes an invalid selection, an additional transaction fee may be incurred. In any event, there is no incentive for the customer to select Debit instead of Credit.

Some financial card authorization networks maintain a Bank Identification Number (BIN) File that contains card information that provides additional insight into whether the cards in a particular range of cards are credit-only, debit-only, or dual-mode cards. However, there are several problems with using the BIN File. First, the BIN File is extremely large and cannot be sent directly to the POS terminal. Instead, the network host computer generally sends the BIN File to the merchant's host computer periodically (for example, once a week). When a transaction is initiated and the customer selects Debit or Credit, the merchant's POS system dials out to the merchant's host and retrieves the information from the BIN File for the card swiped by the customer. A second problem is that the BIN File is not always accurate. One reason for this is that the BIN File is generally a best guess approximation by the network host based on actual transactions processed over time. Another reason is that card issuers do not cooperate (for competitive reasons) to provide BIN range information to each other, so the information is often incomplete. Card issuers may also be reluctant to share this information because they do not necessarily want the customer to choose debit because this reduces their transaction fee revenue. In any event, once again, there is no incentive for the customer to select Debit instead of Credit.

What is needed in the art is a system and method that overcomes the disadvantages of existing systems and methods by providing a customer with an incentive to select a debit-type financial transaction rather than a credit-type transaction when making a purchase at a POS system. The present invention provides such a system and method.

### SUMMARY OF THE INVENTION

In one aspect, the present invention is a computer-implemented method of encouraging a customer utilizing a financial card to perform a debit-type financial transaction rather than a credit-type transaction at a merchant. The method includes offering the customer a price-per-unit (PPU) discount for fuel as a reward for performing a debit-type financial transaction at the merchant; determining that the customer performed the debit-type financial transaction at the merchant; and dispensing fuel to the customer in a subsequent fueling transaction at a PPU reduced from a posted price by an amount equal to the PPU discount. In one embodiment, the dispensing step is performed by a retail fueling merchant different from the merchant where the customer performs the debit-type transaction. In this case, a redeemed discount is calculated by multiplying the PPU discount by the number of units of fuel purchased in the fueling transaction, the redeemed discount is provided to a clearing mechanism, and the redeemed discount is allocated between the merchant and the retail fueling merchant.

In another aspect, the present invention is a system for encouraging a customer utilizing a financial card to perform a debit-type financial transaction rather than a credit-type transaction at a merchant. The customer is offered a PPU discount for fuel as a reward for performing the debit-type financial transaction. The system includes a point-of-sale (POS) system at the merchant comprising means for determining that the customer performed the debit-type financial transaction at the merchant; and means, responsive to a determination that the customer performed the debit-type financial transaction, for awarding the PPU discount to the customer. The system also includes a fuel dispenser for dispensing fuel to the customer in a subsequent fueling transaction, wherein the dispenser has access to the customer's PPU discount and reduces a posted price for the fuel by an amount equal to the PPU discount.

The system may also include a database for storing the amount of the customer's PPU discount, and a fuel dispenser controller having access to the database. The controller includes means for determining that the customer has initiated a subsequent purchase of fuel; means for retrieving the amount of the PPU discount from the database; and means for discounting the price of the fuel posted on the fuel dispenser by the amount of the PPU discount. In one embodiment, the fuel dispenser is located at a retail fueling merchant different from the merchant where the customer performs the debit-type transaction. In this case, the system includes a redeemed discounts calculator for calculating a redeemed discount by multiplying the PPU discount by the number of units of fuel purchased in the fueling transaction; and a clearing mechanism for receiving the redeemed discount and allocating the redeemed discount between the merchant and the retail fueling merchant.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a flow chart illustrating the steps of an embodiment of a method of awarding a PPU discount for fuel in exchange for a customer's selection of a debit financial transaction;

FIG. 2 is a flow chart illustrating the steps of an embodiment of a method of redeeming and clearing the PPU discount for fuel in accordance with the teachings of the present invention;

FIG. 3 is a simplified block diagram of an embodiment of the system of the present invention; and

FIG. 4 is a flow chart illustrating the steps of another embodiment of a method of awarding a PPU discount for fuel in exchange for a customer's selection of a debit financial transaction.

### DETAILED DESCRIPTION OF EMBODIMENTS

The present invention provides an incentive to a consumer to select Debit as the mode of payment for a financial transaction by awarding the customer a price-per-unit (PPU) discount on fuel if the customer performs a debit transaction rather than a credit transaction. The invention also makes it easier for the customer to select Debit by eliminating one of the steps that the customer is currently required to perform. When the customer swipes a card, the POS system accesses the BIN File in the merchant's host computer and determines whether the card is a credit only, debit only, or dual-mode card. If the card is identified as being credit only, the transaction is automatically initiated as a credit transaction. If the card is identified as being debit only, the terminal displays the message Enter PIN”. Thereafter, the transaction is completed as a debit transaction. If the card is identified as a dual-mode card, or if the mode of the card cannot be determined from the BIN File, the terminal displays the message “Enter PIN or Press Credit”. This message eliminates the need for the preliminary message “Press Debit or Credit”, followed by the additional message “Enter your PIN” if Debit was selected.

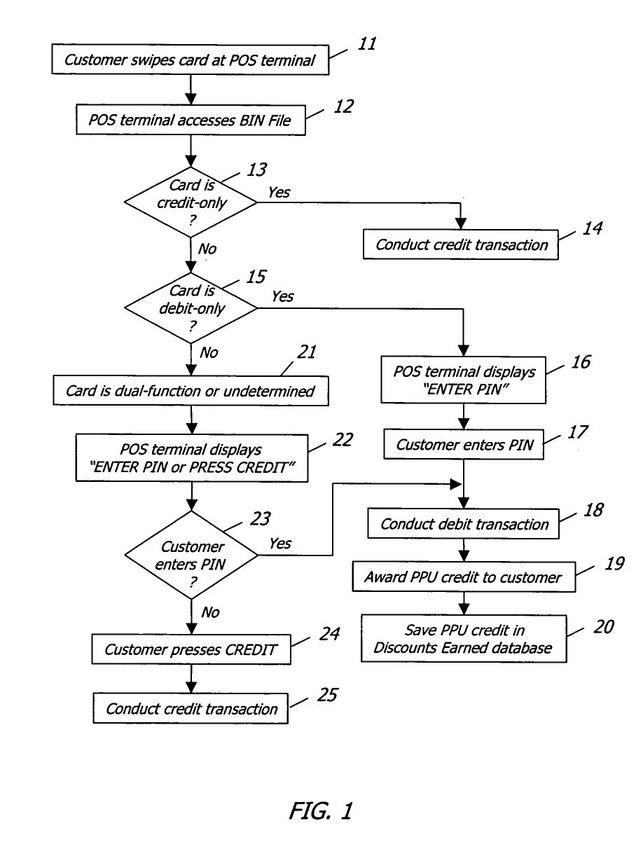

FIG. 1 is a flow chart illustrating the steps of an embodiment of a method of awarding a PPU discount for fuel in exchange for a customer's selection of a debit financial transaction. At step 1 1, a customer swipes a financial card at a POS terminal. At step 12, the POS terminal access the BIN File either in a local database or at the merchant's host computer. At step 13, it is determined from the information in the BIN File whether the card is a credit-only card. If so, the method moves to step 14 and conducts a credit transaction. However, if the card is not a credit-only card, the method moves to step 15 where it is determined from the information in the BIN File whether the card is a debit-only card. If so, the method moves to step 16 where the POS terminal displays “Enter PIN”. At step 17, the customer enters his/her PIN, and at step 18 a debit transaction is conducted.

As a reward for using a debit card, the customer is awarded a PPU discount on fuel at step 19. In one embodiment, the PPU discount is awarded each time the customer performs a debit transaction. In another embodiment, the PPU discount is awarded after one or more award criteria are met. For example, the customer may have to perform a predefined number of debit transactions, or may have to purchase a predefined threshold amount of goods or purchase a cross-marketed product in addition to performing the debit transaction(s). At step 20, the PPU discount is saved in a Discounts-Earned database.

If it is determined at step 15 that the card is not a debit-only card, and thus is not a credit-only card or a debit-only card, the method moves to step 21 where it is concluded that the card is either a dual-mode card or the payment mode of the card cannot be determined from the BIN File. The method then moves to step 22 where the POS terminal displays “Enter PIN or Press Credit”. At step 23, it is determined whether the customer entered a PIN. If so, the method moves to step 18 and conducts a debit transaction. At steps 19 and 20, the customer is awarded the PPU discount and the discount is stored in the Discounts-Earned database. If the customer did not enter a PIN at step 23, the method moves to step 24 where the customer presses Credit. The method then moves to step 25 and conducts a credit transaction.

The present invention thus provides an incentive to the customer by offering a PPU discount on the purchase of fuel in exchange for the customer's selection of a debit transaction. The fuel may be sold by the merchant or by a retail fueling merchant who has a cross-marketing agreement in place with the merchant. The amount of the PPU discount may be a fixed amount such as ten cents per gallon, or may vary depending on other factors such as the number of times the customer selects Debit in a predefined time period, the amount of the financial transaction, whether a cross-marketed product was purchased, or the amount of fuel the customer purchases with the card at the retail fueling merchant. For example, the first five times the customer selects Debit each month at the merchant, the PPU discount may be ten cents per gallon. For the sixth through the tenth time the customer selects Debit at the merchant in the month, the PPU discount may be twenty cents per gallon, and so on. The value of redeemed discounts (i.e., the PPU discount provided to the customer multiplied by the number of gallons purchased) is then allocated between the merchant and the retail fueling merchant in accordance with the agreement between them.

In one embodiment of the present invention, the issuer of the financial card also enters an agreement with the merchant and the retail fueling merchant to provide an incentive for customers to use the issuer's card. This may be an affinity-type relationship in which a bank issues the card with an oil company logo on the face of the card. For example, Wells Fargo may issue a relationship card with an Exxon logo on its face. The incentive for customers to use the Wells Fargo relationship card is that the customer may earn an immediate discount on fuel at Exxon stations by using the relationship card at the merchant. The incentive to select a debit transaction at the merchant is that the customer only earns the discount if a debit transaction is selected. Note that the inventive affinity-type relationship provides an immediate discount at the point of purchase, while existing affinity-type relationships provide delayed credits on the customer's credit card statement at a later date, or points that the customer must redeem when an award level is reached.

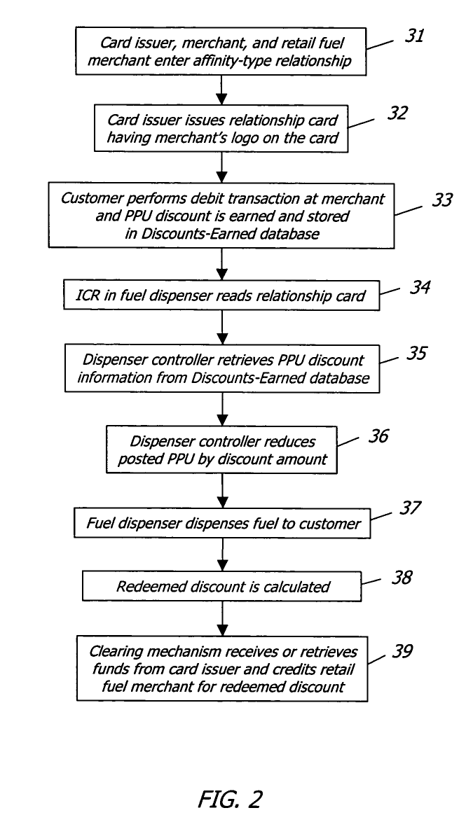

FIG. 2 is a flow chart illustrating the steps of an embodiment of a method of redeeming and clearing the PPU discount for fuel in accordance with the teachings of the present invention. In this embodiment, the card issuer, merchant, and retail fueling merchant have entered an affinity-type agreement at step 31, and the card issuer has issued a relationship card having the merchant's logo on the card at step 32. For purposes of the present invention, the card may be a debit-only card or a dual-mode card.

At step 33, when the customer uses the relationship card to conduct a debit-type transaction at the merchant, a PPU discount for fuel is earned and stored in the Discounts-Earned database. The customer subsequently uses the relationship card to purchase fuel at the participating retail fueling merchant, and the island card reader (ICR) in the fuel dispenser reads the relationship card at step 34. At step 35, the dispenser controller retrieves the PPU discount information from the Discounts-Earned database. At step 36, the dispenser controller immediately lowers the posted street price displayed on the dispenser by the amount of the PPU discount retrieved from the Discounts-Earned database. The PPU discount may be a fixed amount such as 10 cents per gallon, or may be a percentage discount, which fluctuates with the posted price of the fuel. For example, if the affinity-type agreement between the bank, the merchant, and the retail fueling merchant recites a five percent discount, and the posted street price of the fuel is $2.00 per gallon, the customer sees the price on the dispenser drop by 10 cents per gallon when the dispenser reads the card. If the posted price is $3.00 per gallon, the customer sees the price drop by 15 cents per gallon when the dispenser reads the card. At step 37, the fuel dispenser dispenses fuel to the customer at the reduced PPU. From the customer's perspective, the transaction is complete when the fuel purchase transaction is completed. No future events or actions on the part of the customer are required to utilize an earned reward.

At step 38, a redeemed discount is calculated. In the preferred embodiment, a dollar amount of the redeemed discount is calculated by multiplying the PPU discount by the number of units of fuel purchased in the transaction. At step 39, a clearing mechanism tracks the redeemed discounts, and performs settlement procedures by exchanging funds between the parties to the affinity-type agreement. For example, the clearing mechanism may receive or retrieve funds from the card issuer, and credit those funds to the retail fueling merchant. In this scenario, the retail fueling merchant always receives the posted street price for the fueling transaction. The card issuer funds the discounts from its credit card transaction fees. In another scenario, the merchant may also provide part of the funds to the retail fueling merchant. In this scenario, the merchant may fund its part of the discount from transaction fees that were saved as a result of the customer selecting a debit transaction instead of a credit transaction. In yet another scenario, a vendor of a cross-marketed product, which was one of the necessary criteria for awarding the discount, provides funds to cover all or part of the discount.

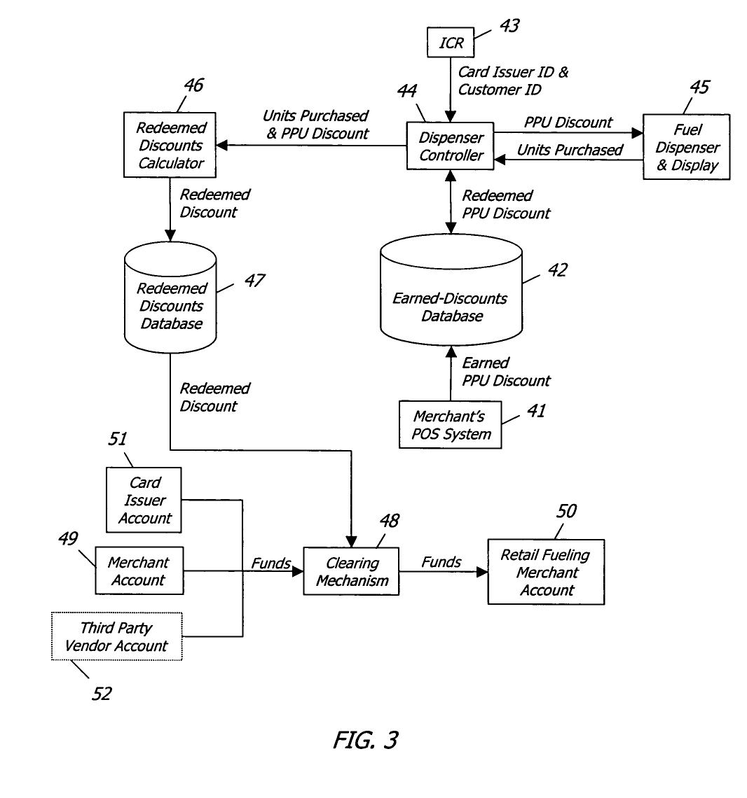

FIG. 3 is a simplified block diagram of an embodiment of the system of the present invention. When a customer performs a debit transaction at the merchant's POS system 41, a PPU discount is earned, and the earned PPU discount is stored in the Earned-Discounts database 42. As previously noted, the PPU discount may be earned solely for performing a debit transaction, or may also or alternatively require that other criteria be met, such as using a relationship card subject to an affinity-type agreement, purchasing more than a threshold amount of goods, or purchasing a cross-marketed product.

Subsequently, when the customer uses the card to purchase fuel at the retail fueling merchant, the Island Card Reader (ICR) 43 in the fuel dispenser (or other input device) reads the magnetic strip on the relationship card. The card information may also be input by other technologies such as a radio frequency identification (RFID) controller with read/write capability, a contactless smart card reader, an audio recognition device, a biometric recognition device, an optical reader, and the like. The BIN range is utilized to identify the card issuer, and a card issuer ID and the customer ID are passed to a dispenser controller 44. Alternatively, the ICR may send the card number to the dispenser controller, and the controller may determine the identification of the card issuer and the customer. The dispenser controller uses the card issuer ID and/or customer ID to access the Earned-Discounts database 42 and retrieve an associated redeemed PPU discount. The controller then reduces the posted street price on the dispenser display by the amount of the associated PPU discount, and causes the fuel dispenser 45 to dispense the fuel at a discounted price.

When the customer indicates the transaction is complete (for example by replacing the fuel nozzle in its holder), the number of units of fuel purchased is determined by the dispenser controller 44, which then sends the number of units of fuel purchased and the PPU discount to a redeemed discounts calculator 46. The calculator may be incorporated into the dispenser controller, or may be implemented separately. The calculator preferably calculates the amount of the redeemed discount by multiplying the PPU discount by the number of units of fuel purchased in the transaction. The redeemed discount may then be stored in a redeemed discount database 47 where it is associated with the card issuer, the merchant, the retail fueling merchant, and optionally, a third party vendor if a cross-marketed product was involved.

A clearing mechanism 48 interfaces with the redeemed discount database, and retrieves the amount of the redeemed discount. The clearing mechanism then transfers funds for the amount of the redeemed discount between the parties of the agreement in accordance with the terms of the agreement. For example, funds may be drawn from the merchant's account 49 and provided to the retail fueling merchant's account 50 if the discount was awarded purely because the customer performed a debit transaction and/or purchased a threshold amount of goods from the merchant. If an affinity-type agreement was involved with the card issuer, the clearing mechanism may also or alternatively obtain funds from the card issuer's account 51 and provide the funds to the retail fueling merchant to cover the cost of the discount. Likewise, if a cross-marketing agreement was involved with a third party vendor, the clearing mechanism may also or alternatively obtain funds from the third party vendor's account 52 and provide the funds to the retail fueling merchant to cover the cost of the discount.

Thus, the customer receives an immediate reward, the retail fueling merchant receives the posted street price for the fueling transaction, and the merchant, the card issuer, and the third party vendor fund the discount.

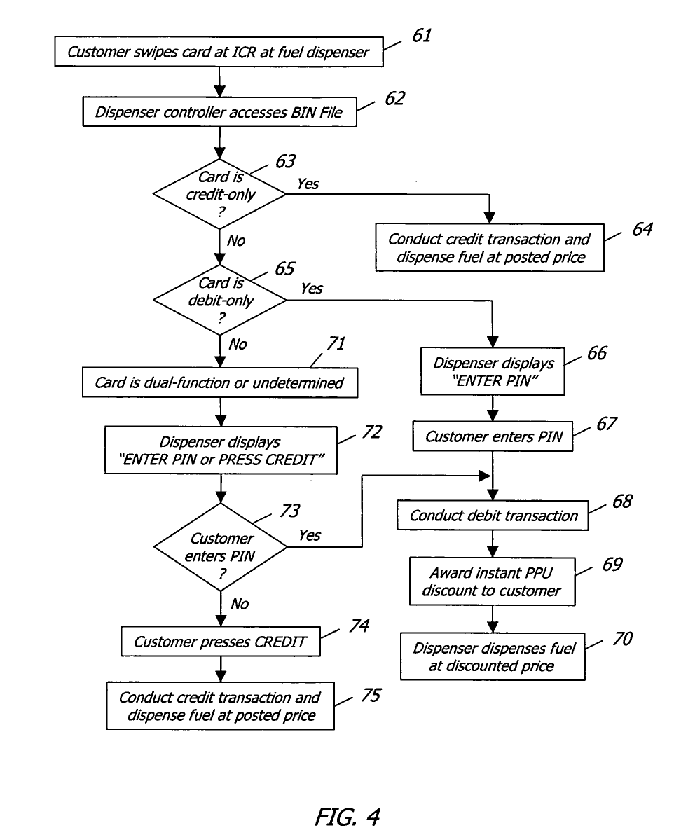

FIG. 4 is a flow chart illustrating the steps of another embodiment of a method of awarding a PPU discount for fuel in exchange for a customer's selection of a debit financial transaction. In this embodiment, an instant PPU discount is provided when the customer chooses to perform a debit transaction when purchasing fuel at the retail fueling merchant. Since the discount is instant, an Earned-Discounts database is not required.

At step 61, a customer swipes a financial card at the ICR of a fuel dispenser at the retail fueling merchant. At step 62, the dispenser controller access the BIN File either in a local database or at the retail fueling merchant's host computer. At step 63, it is determined from the information in the BIN File whether the card is a credit-only card. If so, the method moves to step 64 and conducts a credit transaction, dispensing fuel to the customer at the posted price. However, if the card is not a credit-only card, the method moves to step 65 where it is determined from the information in the BIN File whether the card is a debit-only card. If so, the method moves to step 66 where the dispenser displays “Enter PIN”. At step 67, the customer enters his/her PIN, and at step 68 a debit transaction is conducted.

As a reward for using a debit card, the customer is awarded an instant PPU discount at step 69. At step 70, the dispenser dispenses fuel to the customer at a price that is discounted from the posted price by the amount of the instant PPU discount.

If it is determined at step 65 that the card is not a debit-only card, and thus is not a credit-only card or a debit-only card, the method moves to step 71 where it is concluded that the card is either a dual-mode card or the payment mode of the card cannot be determined from the BIN File. The method then moves to step 72 where the dispenser displays “Enter PIN or Press Credit”. At step 73, it is determined whether the customer entered a PIN. If so, the method moves to step 68 and conducts a debit transaction. At steps 69 and 70, the customer is awarded the instant PPU discount, and the dispenser dispenses fuel to the customer at the discounted price. If the customer did not enter a PIN at step 73, the method moves to step 74 where the customer presses Credit. The method then moves to step 75 and conducts a credit transaction, dispensing fuel to the customer at the posted price.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A computer-implemented method of encouraging a customer utilizing a financial card to perform a debit-type financial transaction rather than a credit-type transaction at a merchant, said method comprising:
offering the customer a price-per-unit (PPU) discount for fuel as a reward for performing a debit-type financial transaction at the merchant;
determining that the customer performed the debit-type financial transaction at the merchant; and
dispensing fuel to the customer in a subsequent fueling transaction at a PPU reduced from a posted price by an amount equal to the PPU discount.

2. The method of claim 1, wherein the step of offering the customer a PPU discount includes increasing the PPU discount as a reward for performing a plurality of debit-type transactions at the merchant over a period of time.

3. The method of claim 1, wherein the step of offering the customer a PPU discount includes offering the PPU discount only if the customer performs the debit-type transaction and purchases more than a threshold amount of goods or services at the merchant.

4. The method of claim 1, wherein the step of offering the customer a PPU discount includes offering the PPU discount only if the customer performs the debit-type transaction and purchases at least one cross-marketed product or service at the merchant.

5. The method of claim 1, further comprising, after the step of determining that the customer performed a debit-type financial transaction, the steps of:
storing the amount of the earned PPU discount in a database;
determining by a fuel dispenser controller that the customer has initiated a subsequent purchase of fuel;
retrieving by the fuel dispenser controller, the amount of the PPU discount from the database; and
discounting the price of the fuel posted on the fuel dispenser by the amount of the PPU discount.

6. The method of claim 5, wherein:
the step of storing the amount of the earned PPU discount in a database includes associating the earned PPU discount with a customer identifier, said customer identifier being discernable by reading the customer's financial card;
the step of determining that the customer has initiated a subsequent purchase of fuel includes discerning the customer identifier upon reading the customer's financial card at the dispenser; and
the step of retrieving the amount of the PPU discount from the database includes retrieving the PPU discount associated with the customer identifier.

7. The method of claim 1, wherein the PPU discount is a percentage of the posted price of the fuel, and the method further comprises, prior to the dispensing step, the step of calculating a current PPU discount based on the posted price of the fuel and the percentage PPU discount.

8. The method of claim 1, wherein the PPU discount is a fixed discount value that does not vary with the posted price of the fuel.

9. The method of claim 1, wherein the dispensing step is performed by a retail fueling merchant different from the merchant where the customer performs the debit-type transaction.

10. The method of claim 9, further comprising:
calculating a redeemed discount by multiplying the PPU discount by the number of units of fuel purchased in the fueling transaction;
providing the redeemed discount to a clearing mechanism; and
allocating the redeemed discount between the merchant and the retail fueling merchant.

11. The method of claim 10, wherein the step of providing the redeemed discount to a clearing mechanism includes:
storing the redeemed discount in a redeemed discounts database; and
interfacing the clearing mechanism with the redeemed discounts database.

12. The method of claim 10, wherein the allocating step includes transferring funds by the clearing mechanism from an account associated with the merchant to an account associated with the retail fueling merchant, wherein the transferred funds are equal to the redeemed discount.

13. The method of claim 1, wherein the financial card is a dual-mode card that provides the customer with an option to select either a debit-type transaction or a credit-type transaction.

14. The method of claim 13, wherein the step of determining that the customer performed a debit-type financial transaction at the merchant includes:
determining by a point-of-sale (POS) system at the merchant that the financial card is a dual-mode card;
presenting the customer with an option to enter a personal identification number (PIN) associated with the debit-type transaction, or to elect to perform a credit-type transaction; and
determining that the customer entered the PIN.

15. The method of claim 1, wherein the merchant is a retail fueling merchant and the offering, determining, and dispensing steps are performed by a fuel dispenser at the retail fueling merchant, wherein the PPU discount is immediately applied to reduce the posted price when the customer selects to perform the debit-type transaction.

16. A system for encouraging a customer utilizing a financial card to perform a debit-type financial transaction rather than a credit-type transaction at a merchant, wherein the customer is offered a price-per-unit (PPU) discount for fuel as a reward for performing the debit-type financial transaction, said system comprising:
a point-of-sale (POS) system at the merchant comprising:
means for determining that the customer performed the debit-type financial transaction at the merchant; and
means, responsive to a determination that the customer performed the debit-type financial transaction, for awarding the PPU discount to the customer; and
a fuel dispenser for dispensing fuel to the customer in a subsequent fueling transaction, wherein the dispenser has access to the customer's PPU discount and reduces a posted price for the fuel by an amount equal to the PPU discount.

17. The system of claim 16, wherein the means for awarding the PPU discount to the customer includes means for increasing the PPU discount as a reward for performing a plurality of debit-type transactions at the merchant over a period of time.

18. The system of claim 16, wherein the POS system also includes means for determining whether the customer purchased more than a threshold amount of goods or services at the merchant, and the means for awarding the PPU discount to the customer includes means for awarding the PPU discount only if the customer performed the debit-type transaction and purchased more than a threshold amount of goods or services at the merchant.

19. The system of claim 16, wherein the POS system also includes means for determining whether the customer purchased at least one cross-marketed product or service at the merchant, and the means for awarding the PPU discount to the customer includes means for awarding the PPU discount only if the customer performed the debit-type transaction and purchased at least one cross-marketed product or service at the merchant.

20. The system of claim 16, further comprising:
a database for storing the amount of the customer's PPU discount; and
a fuel dispenser controller having access to the database, said controller comprising:
means for determining that the customer has initiated a subsequent purchase of fuel;
means for retrieving the amount of the PPU discount from the database; and
means for discounting the price of the fuel posted on the fuel dispenser by the amount of the PPU discount.

21. The system of claim 20, wherein the PPU discount is a percentage of the posted price of the fuel, and the means for discounting the price of the fuel includes means for calculating a current PPU discount based on the posted price of the fuel and the percentage PPU discount.

22. The system of claim 20, wherein the PPU discount is a fixed discount value that does not vary with the posted price of the fuel.

23. The system of claim 20, wherein the fuel dispenser is located at a retail fueling merchant different from the merchant where the customer performs the debit-type transaction.

24. The system of claim 23, further comprising:
a redeemed discounts calculator for calculating a redeemed discount by multiplying the PPU discount by the number of units of fuel purchased in the fueling transaction; and
a clearing mechanism for receiving the redeemed discount, and allocating the redeemed discount between the merchant and the retail fueling merchant.

25. The system of claim 24, wherein the clearing mechanism includes means for transferring funds from an account associated with the merchant to an account associated with the retail fueling merchant, wherein the transferred funds are equal to the redeemed discount.

26. The system of claim 16, wherein the POS system also includes:
means for determining whether the financial card is a dual-mode card that provides the customer with an option to select either a debit-type transaction or a credit-type transaction;
means, responsive to a determination that the financial card is a dual-mode card, for presenting the customer with an option to enter a personal identification number (PIN) associated with the debit-type transaction, or to elect to perform a credit-type transaction; and
means for determining that the customer entered the PIN.
